(19) United States
(12) Patent Application Publication
(10) Pub. No.: US 2007/0167193 A1
(43) Pub. Date: Jul. 19, 2007

(54) Portable wireless terminal

(76) Inventor: Minoru Ogino, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/333,478

(22) Filed: Jan. 17, 2006

(51) Int. Cl. H04B 1/38

(52) U.S. Cl. 455/566

(57) ABSTRACT

A portable wireless terminal has a GPS receiver which obtains the position information of the portable wireless terminal from a GPS satellite, a display which displays an image, a storage device which stores an image database in which common coordinates are defined in each of the portable wireless terminals without relying on the resolution of the display, a control unit which creates display screen information on the basis of the position information and the image database, and a wireless communication unit which transmits the display screen information to another portable wireless terminal. The wireless communication unit receives the display screen information transmitted from another portable wireless terminal. The control unit synthesizes the received display screen information with the image database stored in the storage device, to create a display image, and displays the synthesized display image on the display.

### BACKGROUND

The present invention relates to a portable wireless terminal with a function of transmitting image information.

Recently, the portable wireless terminals such as transceivers with GPS (Global Positioning Systems) installed have been popular in the public, and the functions of specifying the positions of the portable wireless terminals are provided. GPS is a system for specifying the positions of the reception points by receiving navigation electric wave from twenty-four artificial satellites that had been launched by the United States Department of Defense. The position information of a portable wireless terminal is obtained via GPS, and the position information is superimposed on map information and displayed as an image, whereby the position of the portable wireless terminal can be displayed on a screen. U.S. Pat. No. 6,373,430 discloses a system for displaying the position information as an image by obtaining the position information of a portable wireless terminal having a GPS receiver on the basis of satellite signals received by the portable wireless terminal, and then transmitting the position information to another portable wireless terminal.

### SUMMARY

In the portable wireless terminals installed with such function of displaying the position information, easy visual discrimination of the positions, conditions, and the like of the portable wireless terminal is required.

An object of the present invention, therefore, is to achieve the easy visual discrimination of the positions and conditions of a portable wireless terminal with GPS installed.

In order to achieve the object, the portable wireless terminal of the present invention has a GPS receiver which obtains the position information of the portable wireless terminal from a GPS satellite, a display which displays an image, a storage device which stores an image database in which common coordinates are defined in each of the portable wireless terminals without relying on the resolution of the display, a control unit which creates display screen information on the basis of the position information and the image database, and a wireless communication unit which transmits the display screen information to another portable wireless terminal. The wireless communication unit receives the display screen information transmitted from another portable wireless terminal. The control unit synthesizes the received display screen information with the image database stored in the storage device, to create a display image, and displays the synthesized display image on the display.

### DESCRIPTION OF THE DRAWINGS

FIG. 1 is a system configuration diagram of the portable wireless terminal related to the present embodiment;

FIG. 2 is a figure showing a data format of the display screen information related to the present embodiment;

FIG. 3 is a figure showing a format of a screen database related to the present embodiment;

FIG. 4 is a figure showing an image which is displayed on the display of a transmitting terminal related to the present embodiment;

FIG. 5 is a figure showing an image which is displayed on the display of a receiving terminal related to the present embodiment;

FIG. 6 is a figure showing an image which is displayed on the display of the receiving terminal related to the present embodiment;

FIG. 7 is a figure showing a data format of the display screen information transmitted by an icon data transmission system; and

FIG. 8 is a figure showing a data format of the display screen information transmitted by a bitmap data transmission system.

### DETAILED DESCRIPTION

An embodiment of the present invention is described hereinafter with reference to each of the drawings.

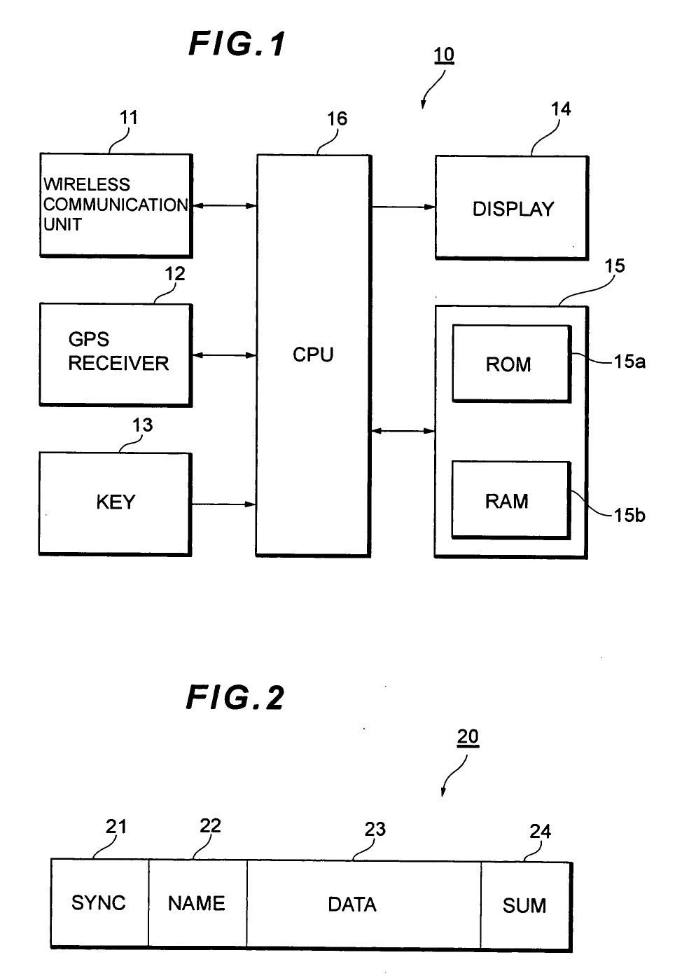

FIG. 1 is a figure showing a portable wireless terminal 10 related to the present embodiment. The portable wireless terminal 10 has a wireless communication unit 11, a GPS receiver 12, a key 13, a display 14, a storage device 15, and a CPU 16.

The wireless communication unit 11 performs wireless communication with another portable wireless terminal. The GPS receiver 12 receives satellite electric wave from a GPS satellite, and obtains the position information of the portable wireless terminal 10. The key 13 is used for operating the portable wireless terminal 10 (control of visual communication and voice communication, for example). The display 14 displays an operation screen showing various settings, or displays the position information of another portable wireless terminal. The storage device 15 has a ROM 15a and RAM 15b. A screen database described hereinafter is stored in the ROM 15a. The ROM 15b functions as a work area for creating a display screen. The CPU 16 creates display screen information on the basis of the position information of the portable wireless terminal 10, which is received by the GPS receiver 12, and transmits the display screen information to another portable wireless terminal, or synthesizes display screen information received from another portable wireless terminal with the screen database, and thereafter displays thus obtained image on the display 14.

It should be noted that a “transmitting terminal” and a “receiving terminal” described hereinafter are portable wireless terminals having the system configuration shown in FIG. 1.

FIG. 2 shows a data format 20 of the display screen information. The data format 20 has a synchronization code (SYNC) 21, a transmitting terminal name (NAME) 22, a display screen information (DATA) 23, and a check sum (SUM) 24. The synchronization code 21 is a start of the data format 20. The transmitting terminal name 22 is the name of a transmitting terminal. The display screen information 23 is image data created on the basis of the position information acquired by the portable wireless terminal 10. The check sum 24 is a code for detecting a transmission error of the data format 20.

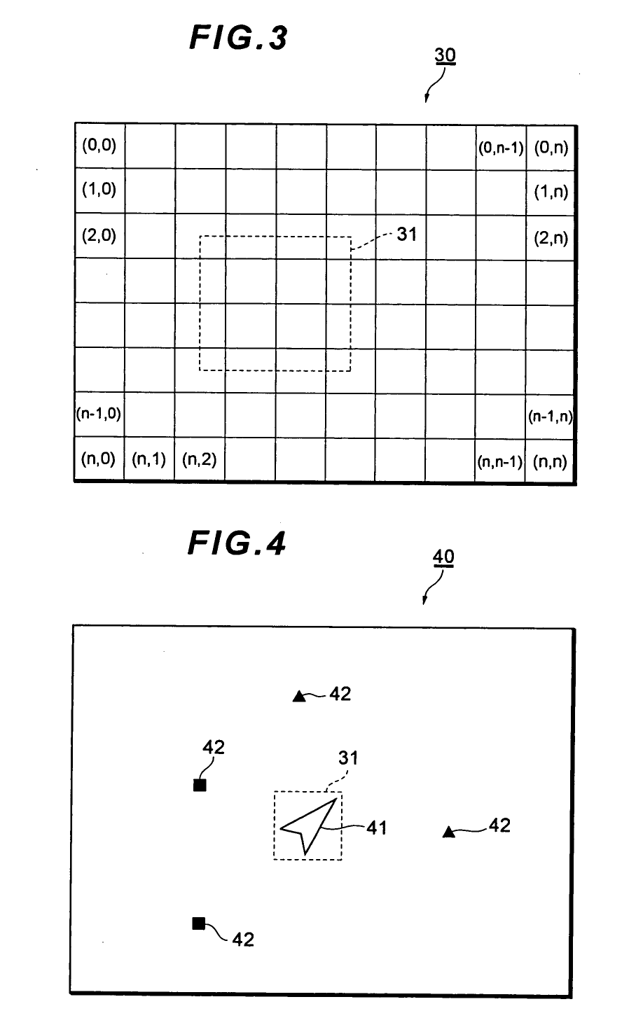

FIG. 3 is shows a format of a screen database 30. The screen database 30 is image data created on the transmitting terminal and the receiving terminal according to the common rules with (for example, map data, picture data, a layout diagram of facilities, an animation image, and the like). The screen database 30 may be a static image or a dynamic image. The screen database 30 has the common coordinates that are defined in the transmitting terminal and the receiving terminal in the form of not relaying on the resolution of the display 14. The screen database 30 may or may not have the position information associated with the coordinates. For example, in the case where the screen database 30 is map data or a layout diagram of facilities, the position information associated with the coordinates is contained in the screen database 30. In the case where the screen database 30 is an animation image, the position information associated with the coordinates is not contained in the screen database 30.

The transmitting terminal creates the display screen information 23 by means of the screen database 30, and transmits the display screen information 23 of a range 31, which is selected by a user, to the receiving terminal. The selected range 31 of the display screen information 23 is specified by designating the coordinates (X, Y) of the screen database 30. On the other hand, the receiving terminal synthesizes the display screen information 23, which is transmitted from the transmitting terminal, with the screen database 30, and displays thus obtained synthesized image data on the display 14. The receiving terminal may store the received display screen information 23 in the storage device 15.

FIG. 4 shows an image 40 which is displayed on the display 14 of the transmitting terminal. The transmitting terminal creates the image 40 on the screen database 30 by using the present position, traveling direction, peripheral map information and the like of the transmitting terminal. In the figure, 31 is a selected range, 41 is an icon indicating the position and traveling direction of the transmitting terminal, and 42 is a landmark.

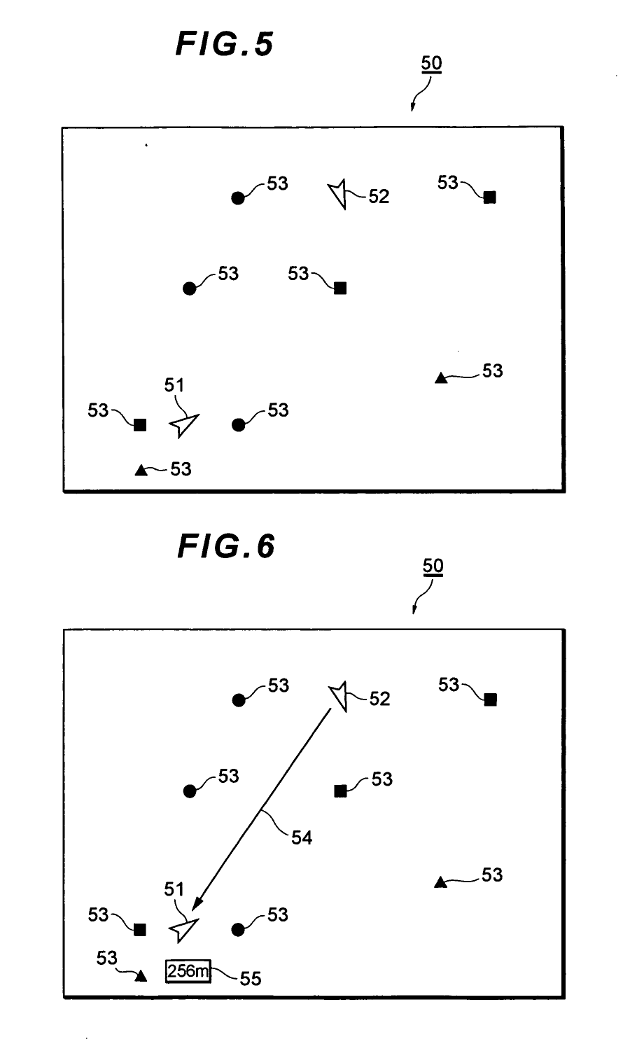

FIG. 5 is shows an image 50 which is displayed on the display 14 of the receiving terminal. The receiving terminal synthesizes the display screen information 23, which is received from the transmitting terminal, with the screen database 30 to create the image 50. In the figure, 51 is the transmitting terminal, 52 is the receiving terminal, and 53 is a landmark. When displaying the image 50 on the display 14 of the receiving terminal, for example, an arrow 54 which indicates the relationship between transmitting terminal 51 and the receiving terminal 52, or a numeric value 55 which indicates the distance between the transmitting terminal 51 and the receiving terminal 52, as shown in FIG. 6, may be additionally displayed. The distance between the transmitting terminal 51 and the receiving terminal 52 can be calculated on the basis of the data of the coordinates defined in the screen database 30.

Next, the transmission system of the display screen information 23 is explained. There are various systems that can be considered as the transmission system of the display screen information 23, and two examples of the system is explained hereinbelow:

(1) Icon Data Transmission System

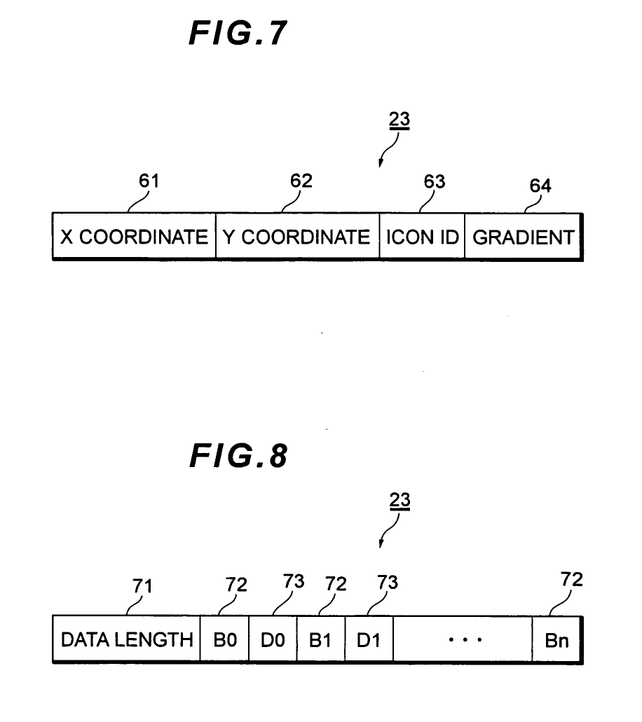

This is a system for transmitting icon data as the display screen information 23. In this transmission system, as shown in FIG. 7, an X-coordinate 61 of the icon, a Y-coordinate 62 of the icon, identification information 63 of the icon, and gradient information 64 of the icon may be contained in the display screen information 23, to transmit the data. As the icon, the one indicating, for example, the transmitting terminal, the receiving terminal, various landmarks, a destination and the like is used.

(2) Bitmap Transmission System

This is a system for transmitting bitmap data as the display screen information 23. In this system, as shown in FIG. 8, a data length 71, blank data 72, and dot data 73 may be contained in the display screen information 23, to transmit the data. The data length 71 indicates the data size of the display screen information 23. The blank data 72 indicates the number of dots in a blank block where no target of display (for example, an icon indicating the transmitting terminal, the receiving terminal, various landmarks, a destination and the like) is present. The dot data 73 indicates the number of dots in a block where the target of display is present. As the display screen information 23, color data may also be contained. Further, the data format of the display screen information 23 is not limited to the example shown in FIG. 8, thus a well-known image compression algorithm may be applied thereto.

According to the present embodiment, easy visual discrimination of the position or conditions (traveling direction and the like) of the portable wireless terminal 10 is possible.

What is claimed is:

1. A portable wireless terminal capable of wireless communication with another portable wireless terminal, comprising:
a GPS receiver which obtains position information of the portable wireless terminal from a GPS satellite;
a display which displays an image;
a storage device which stores an image database in which common coordinates are defined in each of the portable wireless terminals without relying on the resolution of the display;
a control unit which creates display screen information on the basis of the position information and the image database; and
a wireless communication unit which transmits the display screen information to another portable wireless terminal,
wherein the wireless communication unit receives the display screen information transmitted from another portable wireless terminal,
wherein the control unit synthesizes the received display screen information with the image database stored in the storage device, to create a display image, and displays the synthesized display image on the display.

2. The portable wireless terminal according to claim 1, wherein the display screen information includes display coordinates data on the image database of an icon indicating any of a transmitting terminal, a receiving terminal, a landmark, and a destination.

3. The portable wireless terminal according to claim 1, wherein the display screen information includes bitmap data of an icon indicating any of a transmitting terminal, a receiving terminal, a landmark, and a destination.
